(19) United States
(12) Patent Application Publication
(10) Pub. No.: US 2017/0243289 A1
(43) Pub. Date: Aug. 24, 2017

(54) HYBRID TRADING PLATFORM INTEGRATING FIAT AND CRYPTO INVESTMENTS

(71) Applicant: Christopher Michael RUFO, Staten Island, NY (US)

(72) Inventor: Christopher Michael RUFO, Staten Island, NY (US)

(21) Appl. No.: 15/046,994

(22) Filed: Feb. 18, 2016

(51) Int. Cl. G06Q 40/04

(52) U.S. Cl. CPC G06Q 40/04

(57) ABSTRACT

A hybrid trading platform integrating fiat and crypto investments through multiple secure exchanges is provided. The hybrid trading platform manages the flow of information, in part, through market maker and technician modules adapted to provide greater liquidity and quell volatility.

### BACKGROUND OF THE INVENTION

The present invention relates to trading platforms and, more particularly, to a hybrid trading platform integrating fiat and crypto investments through multiple secure exchanges where, in part, the flow of information is managed by market maker and technician modules adapted to provide greater liquidity and quell volatility.

There exists a void in cryptocurrency markets (such as bitcoin) of secure trading exchanges that integrates fiat investment portfolios alongside cryptocurrency (and their derivative products) investments.

The noticeable absence of such platforms is partly explained by the security concerns caused by the digital nature of cryptocurrency and its operation independent of a central bank and outside the ambit of a central government. For example, Mt Gox, which was the largest exchange for bitcoin shut down due to various security breaches and theft of its supply of bitcoins. Moreover, current cryptocurrency systems are not developed by financial professionals who've worked in the industry. As a result, the current cryptocurrency systems do not offer the various derivative products users would like to have on these exchanges. Most importantly, the current cryptocurrency systems lack secure exchange platforms to withstand wave after wave of hacker attempts to bring them down and steal client information, and so cannot offer one fiat-crypto hybrid platform along with various other proprietary information.

Other disadvantages of the current cryptocurrency systems include tendencies for such trading exchanges to become engorged with orders, either significantly slowing down operations or even shutting operations down completely, which in turn respectively either frustrates the inherent goal of all such platforms—the exchange of information—or even stokes volatility in the underlying market. Moreover, the current cryptocurrency systems lack reliable methods of predicting an increase in the levels of volatility in the cryptocurrency markets or procedures to help keep such markets from fluctuating out of control. As can be seen, there is a need for a hybrid trading platform integrating fiat and crypto investments through multiple secure exchanges where, in part, the flow of information is managed by market maker and technician modules adapted to provide greater liquidity and quell volatility.

### SUMMARY OF THE INVENTION

In one aspect of the present invention,

In another aspect of the present invention,

These and other features, aspects and advantages of the present invention will become better understood with reference to the following drawings, description and claims.

### BRIEF DESCRIPTION OF THE DRAWINGS

FIG. 1 is a schematic view of an exemplary embodiment of a general a layout of the present invention;

FIG. 2 is a schematic view of an exemplary embodiment of a navigation toolbar of the present invention;

FIG. 3 is a schematic view of an exemplary embodiment of a charts page of the present invention;

FIG. 4 is a schematic view of an exemplary embodiment of the present invention;

FIG. 5 is a schematic view of an exemplary embodiment of an analysis page of the present invention;

FIG. 6 is a schematic view of an exemplary embodiment of a mining page of the present invention;

FIG. 7 is a schematic view of an exemplary embodiment of a social page of the present invention;

FIG. 8 is a schematic view of an exemplary embodiment of a IRC page of the present invention;

FIG. 9 is a schematic view of an exemplary embodiment of a banking page of the present invention;

FIG. 10 is a schematic view of an exemplary embodiment of a digital wallet of the present invention;

FIG. 11 is a schematic view of an exemplary embodiment of a market maker and technician module of the present invention; and

FIG. 12 is a schematic view of an exemplary embodiment of a crypto derivative pricing/quote module of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a hybrid trading platform integrating fiat and crypto investments through multiple secure exchanges where, in part, the flow of information is managed by market maker and technician modules adapted to provide greater liquidity and quell volatility.

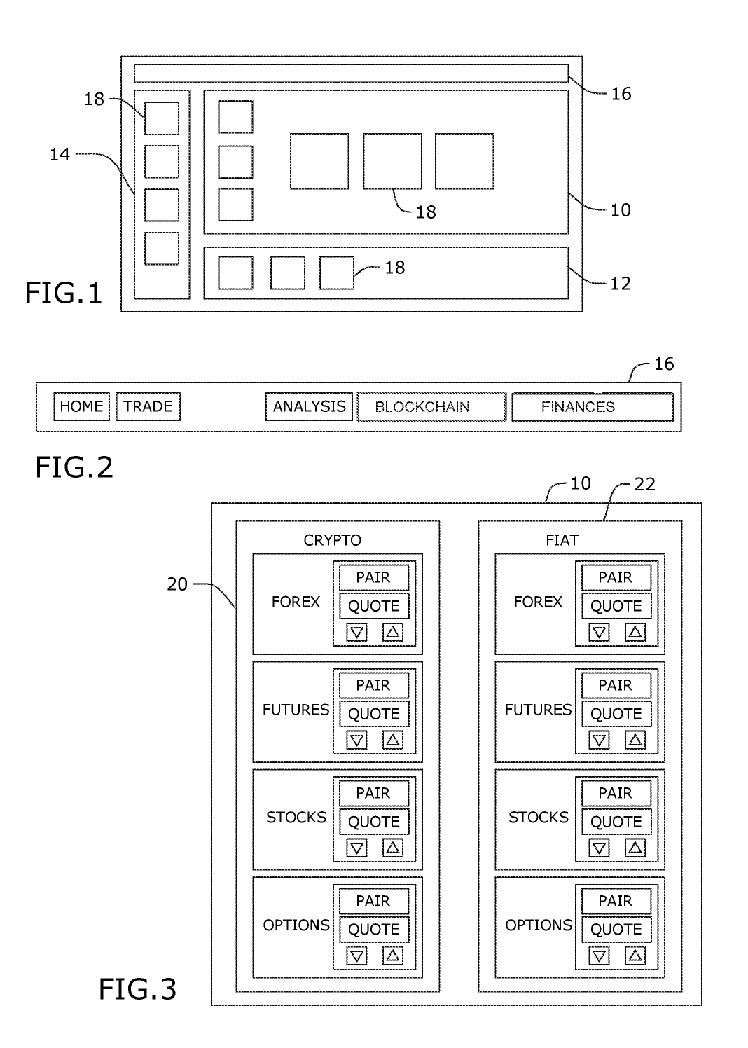

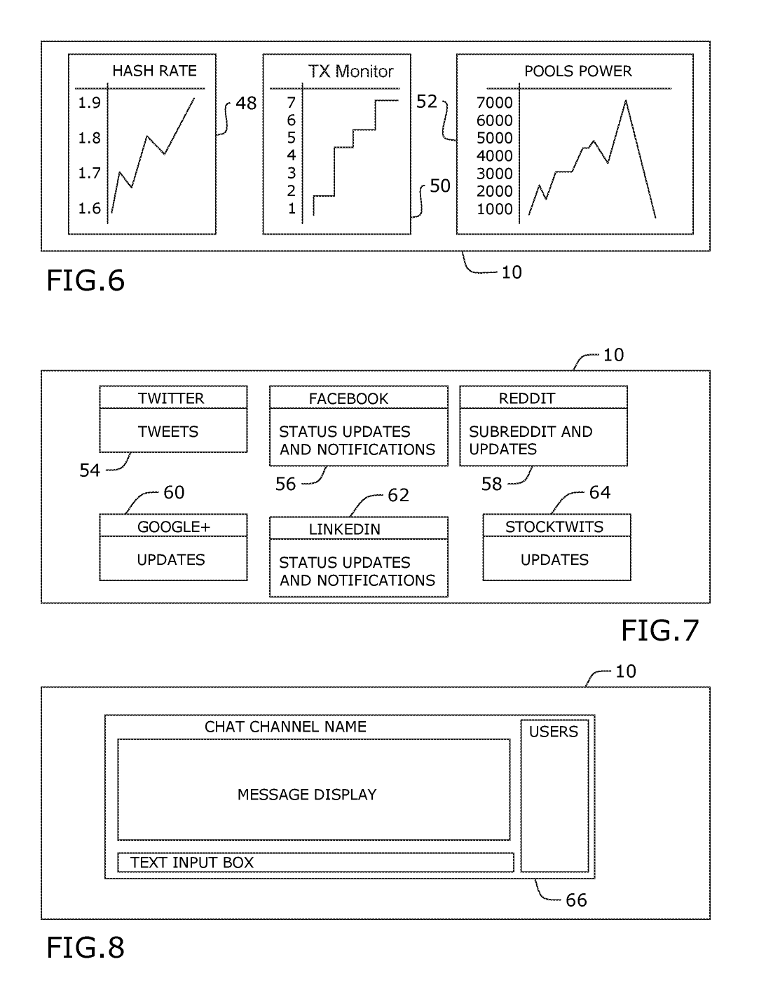

Referring to FIGS. 1 through 12, the present invention may include at least one computer with a user interface. The computer may include at least one processing unit and a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

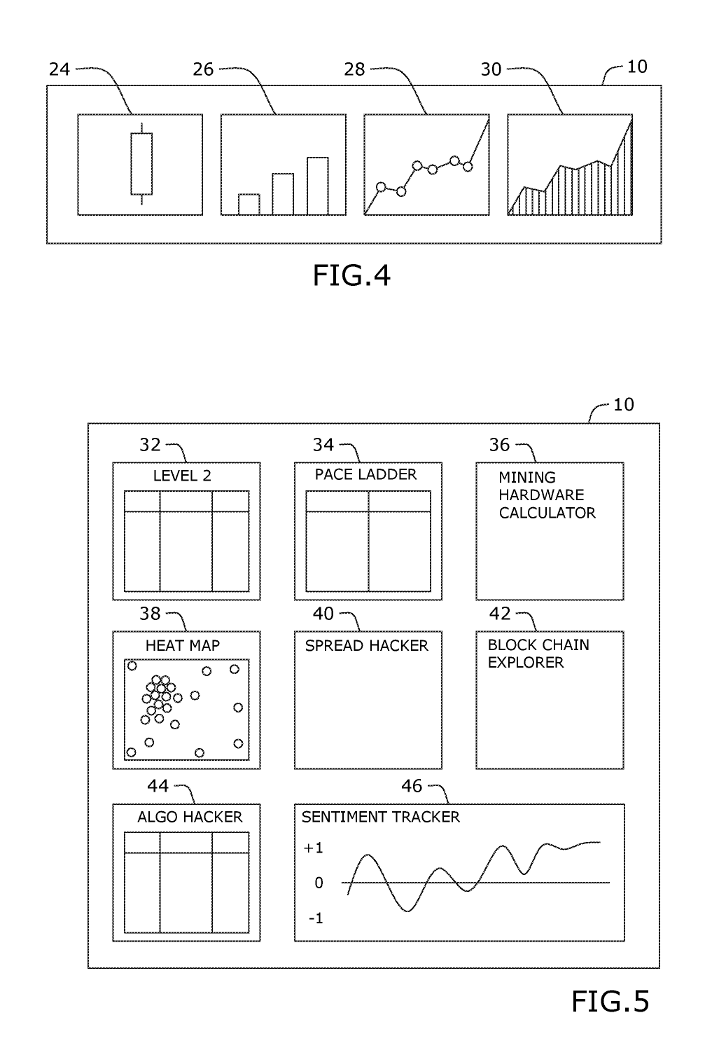

The present invention may include an eBIT hybrid trading platform providing a main display 10 (or user interface) having a bottom display 12, a side display 14, a navigation toolbar 16 and a plurality of widgets 18 for a user to engage, as illustrated in FIGS. 1 and 2. The main display 10 may provide a cryptocurrency data set 20 and a fiat data set 22 on a trading page, as illustrated in FIG. 3. The main display 10 may provide an electronic representation of information provided via the eBIT hybrid trading platform through a candle graph data set 24, a bar graph data set 26, a line graph data set 28, an area graph data set 30 or the like on a charts page, as illustrated in FIG. 4. The plurality of widgets 18 may include a level 2 widget 32, a pace ladder widget 34, a mining hardware calculator widget 36, a heat map widget 38, a spread hacker widget 40, a block chain explorer widget 42, an algo hacker widget 44, a sentiment tracker widget 46, a hash rate widget 48, a payout widget 50, a pools power widget 52, a twitter widget 54, a facebook widget 56, a reddit widget 58, a google+widget 60, a linkedin widget 62, a stockwits widget 64, and the like, wherein the plurality of widget 18 may be provided on an analysis page, a mining page, and a social page on the main display 10 separately or in some combination, as illustrated in FIGS. 5-7.

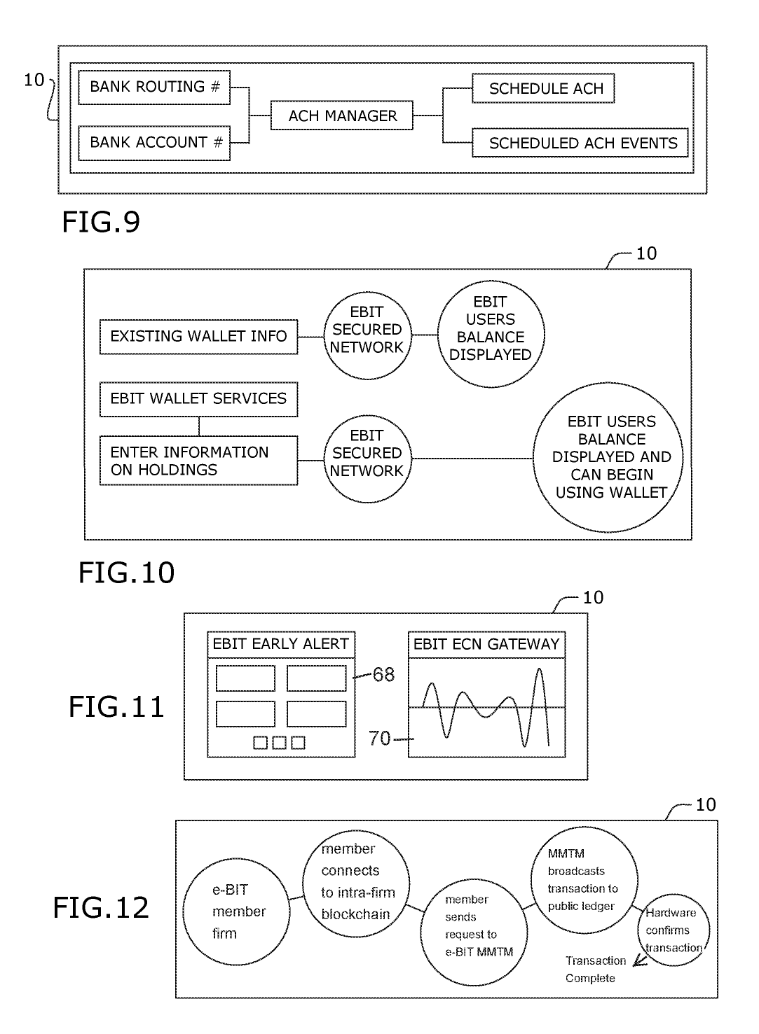

The eBIT hybrid trading platform may include an IRC page providing an IRC chat window 66, as illustrated in FIG. 8. The eBIT hybrid trading platform may include a banking page and a digital wallet page through the main display 10, as illustrated in FIGS. 9 and 10. The eBIT hybrid trading platform may include a proprietary eBIT early alert widget 68 and a proprietary eBIT ECN gateway widget 70 via a market maker and technician module page through the main display 10, as illustrated in FIG. 11. The eBIT hybrid trading platform may include a crypto derivative pricing/quote module through the main display 10, as illustrated in FIG. 12.

As a result, the eBIT hybrid trading platform—a proprietary platform owned by eBIT Inc—is a cryptocurrency exchange integrating customer-users fiat investment portfolios alongside their cryptocurrency investments all on one platform, enabling users to trade their fiat investment portfolio alongside their cryptocurrency portfolio over a highly secured network. Users can choose to use eBIT digital wallet services to safely hold their digital currency (such as bitcoin and litecoin) along with fiat banking information, which may be electronically represented on the main display 10, as illustrated in FIGS. 9 and 10. If the customer already has a digital wallet for storing bitcoin or other alternative cryptocurrency, they can link that to the hybrid trading platform as well, and so view their digital wallet information through the digital wallet page. Users can also link their social media outlets, IRC chat networks, mining pools and more to the hybrid trading platform as well, as illustrated in FIGS. 7, 8, 6 and 3, respectively.

The eBIT hybrid trading platform uses all the clients previously entered proprietary information to build a custom trading platform which is variable in design for each user and can be used to trade the clients fiat and crypto portfolios at will. The way this is done is by using the initial setup wizard to collect all the clients desired proprietary information and storing it for later use. Once the client has finished setting up their platform, the client is asked to log into the system. The client is sent through the eBIT secured exchange network which uses both hardware and software to encrypt and secure information.

### Securing Methods

The eBIT hybrid trading platform embodies novel security methods used for securing the cryptocurrency exchange and market making processes. The securing methods may include an eBIT hybrid trading platform application downloadable file, an eBIT hybrid trading platform setup wizard, an eBIT hybrid trading platform security kernel, an Oracle 12c cloud database or the like, Oracle SuperCluster M6-32 servers or the like, an eBIT secured exchange network, an eBIT hybrid trading platform API, and an eBIT hybrid trading platform GUI.

All information may be stored in a private cloud database cluster as opposed to in a static SQL database location on a single server, is constantly changing and being moved from cloud to cloud so by the time a would be hacker is able to locate and intercept the clients information, figure out a way to decrypt it and use the intercepted information to his/her advantage, it has changed and moved to a new location within the cloud cluster and is using different security keys which to authenticate the clients information within the exchange network, thereby the information may be bouncing around the aforementioned cloud database cluster using various encryption methods every 30-60 seconds. This means that every 30-60 seconds, a new set of encryption keys will be used to authenticate client information and reduces the chances of a hacker being able to successfully use any information that is gathered. The exchange order routing system and modules work the same way, using Oracle M6-32 SuperCluster servers and Oracle 12c cloud databases or other fastest available servers/databases for handing the flow of incoming information. Using the Oracle 12c cloud database cluster to store information in a private cloud and the Oracle M6-32 supercluster servers to handle the immense amount of incoming information in unison builds eBIT secured exchange networks along with eBIT security protocols. These protocols act as the exchange network security kernel which basically tells the exchange network hardware where it can access necessary client information and how to decrypt it for use within the exchange network in as little as a second.

This makes up the API which connects the clients to our network securely, whether they are a market maker using communicating their operations to team members or a retail client simply placing trades. The end result is the clients simply looking at all the information in graphical form through the user interface and/or main display 10. As a result, if an eBIT user has linked proprietary information to the hybrid trading platform, then that information will be encrypted and stored via a private cloud database for later use. Thus when the user logs onto the eBIT hybrid trading platform then the user is sent through the eBIT security kernel and all proprietary information is accessed and displayed via the API/GUI, user interface and/or main display 10, enabling the user to place secure trades while simultaneously accessing their proprietary information and fiat and crypto investment data sets.

### Money Maker and Technician Modules

The eBIT hybrid trading platform incorporates Market Maker/Technician (MMT) modules (or MMTM) into the hybrid trading platform, wherein the MMTM are adapted so that the plurality of exchanges work together and share resources to (a) quell the extreme volatility associated with cryptocurrency and (b) streamline derivative cryptocurrency products to a mass market. The MMT modules are specifically designed for technicians and market makers. In certain embodiments, such MMT modules can only be used by exchanges brought on by eBIT Inc for a nominal annual fee. The MMTM may include an eBIT MMT module API and an eBIT MMT module GUI. The MMT modules enable market makers and technicians to conduct operations needed to grow the broader cryptocurrency market itself (from a products offered and scale of use standpoint) and to make sure cryptocurrency markets are kept stable during times of duress.

Market makers utilizing eBIT MMT modules can log into the secured exchange network, make markets and relay price quotation back to various other exchanges whom are part of the eBIT exchange network. For example, If a company has issued crypto-shares of their company and wishes to make its shares available to the eBIT exchange network and currently has access to an MMT module and is logged in securely to the exchange network, then it may do so by accessing the market makers from various exchanges on the MMT module and offer prices to be relayed to customers. Another example could include a market maker desiring to make a derivative market in cryptocurrency via IRC chat network. They could log into the exchange network securely, access an associated MMT module, then relay the price back to the exchange networks various market makers for quotation.

Technicians can help keep the cryptocurrency markets orderly by using the MMT modules as well. By having multiple exchanges working together on the MMT modules they can share order flow when one exchange becomes too engorged with orders. This process prevents the engorged exchange from shutting its operations down which, in theory, quells at least some volatility in the market. This process also helps to free lines of credit and valuable monetary resources up for the exchanges which provides greater liquidity and stablility for the cryptocurrency market and its end users. The MMT module will have an early warning system built into it which can predict if a major move is about to come and increase the levels of volatility in the cryptocurrency markets. When the 100 day moving average crosses the 50 day moving average on a daily chart, this is the first early alert sent to the various technicians on the MMT modules. Once daily momentum levels increase to three times their normal average this would be our second early alert notification. When daily volume levels increase to three times their normal levels this is the third and final early alert signal sent to the various technicians on the MMT module. From this point on, technicians should have had ample time to begin order queues and re-routing procedures to help keep the market from fluccuating out of control and thus keeping exchange rates for the cryptocurrency in focus, stable. The MMT module will be the cryptocurrency's world first true electronic communication network (ECN) and will greatly enhance the speed in which orders get filled and will help provide greater liquidity by offering a market maker/taker system.

A method of using the present invention may include the following. The eBIT hybrid trading platform disclosed above may be provide, in certain embodiments by downloading the eBIT hybrid trading platform from http://www.ebit.us so that a user may install it on their computer, run the setup wizard which may prompt them for some proprietary information. After that is done, users may be prompted to log into the secured exchange network and begin trading if they desire. For market makers who are part of the eBIT Inc exchange network, they may sign up for an MMT terminal account, download the MMT module to be installed alongside their eBIT hybrid trading platform, run the setup wizard which will prompt them for information and begin conducting operations.

The market maker can connect securely to various channels on IRC chat networks (or whatever conduit the market maker is using to make markets) where over the counter traders price options (and other various derivative products) in bitcoin and other alternative cryptocurrency and make them available to the general public. Once the market maker has made a market, he/she can relay the pricing information back to the eBIT exchange network, securely, for quotation on the hybrid trading platform and other partner exchange quotation systems. The last benefit of the MMT module is that companies that have issued cryptoshares (shares of a company priced in bitcoin and alternative cryptocurrency) can list their shares on the eBIT exchange and use the MMT to help control the supply of shares and derivative products on their shares safely and securely.

Also, the present invention may be used to create derivatives on cryptocurrency, for example one vision eBIT Inc has is bitcoin vs SP500 sprads, bitcoin vs DJIA spreads, weighted averages for merchants who accept cryptocurrency, volatility index for bitcoin and other cryptocurrency and margin fiat investment in cryptocurrency is all being looked at right now.

The present invention is configured to safely and securely communicate all processes with the necessary hardware infrastructure, which creates the secured exchange network that includes the MMT modules

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer-implemented method of quelling volatility in a cryptocurrency trading platform, comprising:
providing a plurality of secure network exchanges hosting a hybrid trading platform having a user interface;
integrating a plurality of fiat investment data sets and a plurality of cyrptocurrency investment data sets in the hybrid trading platform;
producing an electronic representation of the plurality of fiat and cyrptocurrency investment data sets on the user interface;
incorporating at least one MMT module in the hybrid trading platform, wherein each MMT module is configured to:
(a) make markets based in part on the plurality of cyrptocurrency investment data sets; and
(b) regulate the plurality of secure network exchanges;
prompting a user to make a market for the hybrid trading platform comprising at least one of the plurality of cyrptocurrency investment data; and
regulate the plurality of secure network exchanges to equally share the plurality of fiat investment data sets and the plurality of cyrptocurrency investment data sets integrated on the hybrid trading platform.
